(19) United States
(12) Patent Application Publication
(10) Pub. No.: US 2025/0371242 A1
(43) Pub. Date: Dec. 4, 2025

(54) Dynamic Chip Floorplanning Method

(71) Applicant: MEDIATEK INC., Hsin-Chu (TW)

(72) Inventors: Wen-Chieh Chung, Hsinchu City (TW); Sheng-Chuan Yen, Hsinchu City (TW); Te-Wei Chen, Hsinchu City (TW); Chun-Chih Yang, Hsinchu City (TW); Ming-Fang Tsai, Hsinchu City (TW)

(73) Assignee: MEDIATEK INC., Hsin-Chu (TW)

(21) Appl. No.: 18/679,402

(22) Filed: May 30, 2024

(51) Int. Cl. G06F 30/398; G06F 30/392; G06F 115/08

(52) U.S. Cl. CPC G06F 30/398; G06F 30/392; G06F 2115/08

(57) ABSTRACT

A dynamic chip floorplanning method includes a macro placer performing macro placements inside a plurality of intellectual property (IP) cores based on a first reinforcement learning model, a verifier performing criteria verification to check if the macro placements satisfy a predetermined standard, a frame resizer resizing a set of IP cores whose macro placements satisfy the predetermined standard, the set of IP cores being a subset of the plurality of IP cores, and a floorplanner adjusting a floorplan to optimize positions and frames of the plurality of IP cores on chip top based on a second reinforcement learning model when none of the plurality of IP cores is to be further resized.

### BACKGROUND

In the realm of electronic design automation, a floorplan for an integrated circuit serves as a schematic representation of the provisional arrangement of its key functional blocks. During the floorplanning design stage, which occurs early in the hierarchical approach to integrated circuit design, these floorplans are meticulously crafted. The floorplan process takes into account various geometrical constraints, including the placement of bonding pads for off-chip connections, the proximity of line drivers to bonding pads, and the clustering of areas to limit data paths. Additionally, purchased intellectual property blocks (IP-blocks), such as processor cores, come with predefined area allocations. It's important to note that the precise definition of a floorplan can vary based on the specific design methodology being followed. Researchers have explored mathematical models and optimization techniques to find good floorplans, although many of these problems remain computationally challenging. Floorplanning plays a crucial role in shaping the early architecture of integrated circuits, ensuring efficient layout and connectivity.

In certain methodologies, the floorplan can be conceptualized as a partition of the entire chip area into axis-aligned rectangles, each designated to house individual integrated circuit (IC) blocks. This partitioning process is governed by a multitude of constraints and optimization requirements, including considerations related to block area, aspect ratios, and the estimated total interconnect length. The pursuit of optimal floorplans has been a focal point in the field of combinatorial optimization. Unfortunately, most problems associated with finding these optimal floorplans fall into the category of NP-hard (non-deterministic polynomial-time hard) problems, demanding significant computational resources for their resolution. Consequently, practitioners often rely on a variety of optimization heuristics to discover satisfactory solutions. These heuristics aim to strike a balance between efficiency and quality, ensuring that the resulting floorplans satisfy the necessary design criteria while minimizing computational complexity. Therefore, a dynamic chip floorplanning method is required and proposed.

### SUMMARY

An embodiment provides a dynamic chip floorplanning method. The dynamic chip floorplanning method includes a macro placer performing macro placements inside a plurality of intellectual property (IP) cores based on a first reinforcement learning model, a verifier performing criteria verification to check if the macro placements satisfy a predetermined standard, a frame resizer resizing a set of IP cores whose macro placements satisfy the predetermined standard, the set of IP cores being a subset of the plurality of IP cores, and a floorplanner adjusting a floorplan to optimize positions and frames of the plurality of IP cores on chip top based on a second reinforcement learning model when none of the plurality of IP cores is to be further resized.

Another embodiment provides a dynamic chip floorplanning method. The dynamic chip floorplanning method includes a macro placer performing first macro placements inside a plurality of intellectual property (IP) cores based on a first reinforcement learning model, a verifier performing criteria verification to check if the first macro placements satisfy a predetermined standard, and a floorplanner adjusting a floorplan to optimize positions and frames of IP cores on chip top based on a second reinforcement learning model if the first macro placements fail to satisfy the predetermined standard.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a dynamic chip floorplanning method using reinforcement learning according to an embodiment of the present invention.

FIG. 2 is a flowchart of a dynamic chip floorplanning method using reinforcement learning according to an embodiment of the present invention.

### DETAILED DESCRIPTION

Designers universally recognize the critical role of floor planning in achieving high-quality layout and routing (P&R, Placement & Routing) for successful chip design. However, the process of floorplan design is not only time-consuming but also monotonous. The advent of emerging fields like artificial intelligence (AI), high-performance computing (HPC), and hyperscale data centers has further amplified the complexity of chip design, presenting unique architectural challenges. As chip sizes and intricacy continue to grow, the number of macros within an integrated circuit (IC) design has surged. Consequently, floor planning now occupies a significant portion of project schedules, prompting designers to seek efficient methods for achieving superior results while minimizing iterative floor planning efforts.

Traditional floorplanning involves manually placing major functional blocks (macros) within an IC, aiming to achieve power, performance, and area (PPA) targets. However, this manual trial-and-error approach can be time-consuming, especially when dealing with thousands of macros. Designers often face limitations when placing macros at the block edges, which may lead to suboptimal quality or blockages. To address this challenge, automation technologies are emerging, saving significant time and effort.

In the traditional approach to layout planning for integrated circuits (ICs), designers arrange the primary functional blocks (macros) within the chip. This process involves manual trial and error to establish an optimal data flow. Once the macro placement is determined, the remaining space is allocated for standard cells. The overarching objective is to position each block strategically to satisfy the power, performance, and area (PPA) targets specific to the design.

Designers who work within familiar design styles can draw upon their past experiences and knowledge gained from academic institutions to expedite this process. For instance, a designer well-versed in chip layout and routing techniques may optimize power consumption while maintaining the desired performance. However, when dealing with a large number of macros-often reaching tens of thousands-manual adjustments become inefficient. The repetitive nature of layout planning can consume days or even weeks, depending on the chip's size and complexity.

Existing traditional floorplanning solutions impose limitations, particularly in terms of macro placement. Designers are often confined to placing macros along block edges, which may not yield the most optimal results and can lead to blockages or subpar quality. To address these challenges, automation technologies are emerging, streamlining the floorplan design process and enhancing quality-of-results. The future of floor planning lies in intelligent automation, freeing designers to focus on creativity and innovation rather than mundane manual tasks.

A dynamic chip floorplanning method using reinforcement learning is required and proposed. Reinforcement learning is a machine learning training method that operates by rewarding desired behaviors and penalizing undesired ones. In essence, a reinforcement learning agent has the capability to perceive and interpret its environment, take actions, and learn through trial and error. This approach is one of several techniques employed by developers to train machine learning systems. What sets reinforcement learning apart is its ability to empower an agent-whether it's a character in a video game or a robot in an industrial context-to navigate the intricacies of its specific environment. Over time, the agent learns from its interactions with the environment, refining its behaviors through a feedback loop that typically involves rewards and penalties. This iterative process allows the agent to optimize its actions based on the desired outcomes.

In reinforcement learning, developers create a mechanism for rewarding desired behaviors and penalizing negative ones. This approach assigns positive values to favorable actions, motivating the agent to choose them, while negative values discourage undesirable behaviors. The goal is to program the agent to pursue long-term and overall maximum rewards, leading to an optimal solution. These overarching objectives prevent the agent from fixating on less critical goals. Over time, the agent learns to avoid negative outcomes and actively seek positive ones. This learning methodology has been widely adopted in artificial intelligence (AI) to guide unsupervised machine learning using a combination of rewards (positive reinforcement) and penalties (negative reinforcement).

A first reinforcement learning model is built for macro placement. The macro placement is performed according to a static random access memory (SRAM) and a netlist inside a static frame based on the first reinforcement learning model. A second reinforcement learning model is built for floorplanning. The floorplanning is performed to generate frames and positions of intellectual property (IP) cores adaptively to achieve a dense and efficient design based on the second reinforcement learning model.

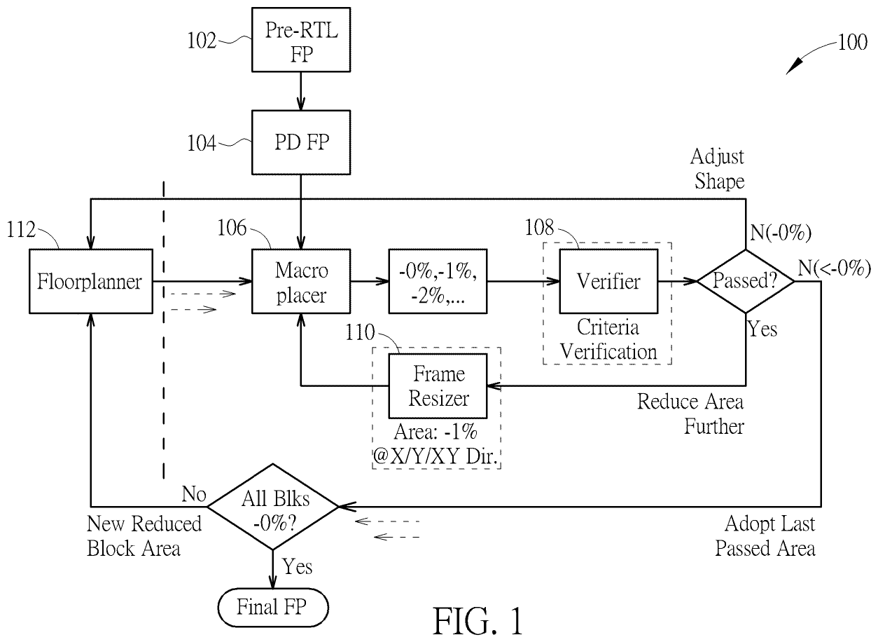

FIG. 1 is a schematic diagram of a dynamic chip floorplanning method 100 using reinforcement learning according to an embodiment of the present invention. During initialization, a pre-register transfer level (RTL) floorplan (FP) 102 is designed and transferred into a physical design (PD) floorplan (FP) 104.

In digital circuit design, RTL is an abstract model of synchronous digital circuits. This model is based on digital signals in hardware registers, memories, and combinational logic. The flow between logical units such as devices and buses is determined by the way their logic operates algebraically.

Register transfer level abstraction models are used in hardware description languages such as Verilog and very high-speed hardware description language (VHDL) to create high-level descriptions of actual circuits, while low-level descriptions and even actual circuits can be derived from high-level descriptions. In modern digital design, design at the register transfer level is the most typical workflow. Logic synthesis tools can build lower-level circuit descriptions from scratchpad transfer-level descriptions.

The PD floorplan 104 provides an initialized floorplan for predetermined frames and positions of intellectual property (IP) cores. In electronic design, a semiconductor intellectual property (IP) core, IP core or IP block is a reusable unit of logic, cell, or integrated circuit layout design that is the intellectual property of one party. IP cores can be licensed to another party or owned and used by a single party. The term comes from the licensing of the patent or source code copyright that exists in the design. Designers of system on chip (SoC), application-specific integrated circuits (ASIC) and systems of field-programmable gate array (FPGA) logic can use IP cores as building blocks.

IP cores are commonly offered as synthesizable RTL in a hardware description language such as Verilog or VHDL. These are analogous to low-level languages such as C in the field of computer programming. IP cores delivered to chip designers as RTL permit chip designers to modify designs at the functional level, though many IP vendors offer no warranty or support for modified designs. IP cores are also sometimes offered as generic gate-level netlists. The netlist is a boolean-algebra representation of the IP's logical function implemented as generic gates or process-specific standard cells. An IP core implemented as generic gates can be compiled for any process technology. A gate-level netlist is analogous to an assembly code listing in the realm of computer programming. A netlist gives the IP core vendor reasonable protection against reverse engineering. Both netlist and synthesizable cores are called soft cores since both netlist and synthesizable cores allow a synthesis, placement and routing (SPR) design flow.

Hard cores (or hard macros) are analog or digital IP cores whose function cannot be significantly modified by chip designers. These are generally defined as a lower-level physical description that is specific to a particular process technology. Hard cores usually offer better predictability of chip timing performance and area for their particular technology. Analog and mixed-signal logic are generally distributed as hard cores. Hence, analog IP cores are provided to chip makers in transistor-layout format. Digital IP cores are sometimes offered in layout format as well. Low-level transistor layouts must obey the target foundry's process design rules. Therefore, hard cores delivered for one foundry's process cannot be easily ported to a different process or foundry. Operators of merchant foundries provide a range of hard-macro IP functions tailored to their proprietary manufacturing processes, which aids in securing customer commitment.

In FIG. 1, a macro placer 106 performs macro placements inside a plurality of IP cores, excluding those that are fixed, utilizing a first reinforcement learning model. A verifier 108 performs criteria verification to check if the macro placements satisfy a predetermined standard. In an embodiment, the predetermined standard encompasses aspects of power, performance, and area (PPA). In another embodiment, the predetermined standard encompasses aspects of global routing congestion, timing, wirelength and hotspot of the macro placements. If any of the plurality of IP cores fails to satisfy the predetermined standard, the floorplan should be adjusted. After adjusting the floorplan, the macro placer 106 performs macro placements inside the plurality of IP cores again until all of the plurality of IP cores satisfy the predetermined standard.

The set of IP cores is a subset of the plurality of IP cores.

Suppose the number of the plurality of IP cores is T, when all of the T IP cores satisfy the predetermined standard, the T IP cores are outputted to a framer resizer 110. The frame resizer 110 tries to reduce the area occupied by some members of the T IP cores by 1% along the x-axis (horizontally), some members of the T IP cores by 1% along the y-axis (vertically), and/or some members of the T IP cores by 1% along both the x and y axes (horizontally and vertically). 1% reduction is merely an example, the percentage of reduction can be another predetermined number. After resizing the T IP cores, the macro placer 106 performs macro placements again to place the macros inside the T resized IP cores. After performing the macro placements, the verifier 108 performs criteria verification again to check if the macro placements of the T resized IP cores satisfy the predetermined standard.

If M of the T resized IP cores fail to satisfy the predetermined standard, it implies that the M IP cores already have minimal sizes and the M resized IP cores are discarded. If N of the T resized IP cores satisfy the predetermined standard, it implies that the N resized IP cores should be further resized where T=M+N.

The N resized IP cores are thus outputted to the frame resizer 110, and the M resized IP cores are not outputted to the frame resizer 110. The frame resizer 110 tries to reduce the area occupied by some members of the N resized IP cores by 18 along the x-axis (horizontally), some members of the N resized IP cores by 1% along the y-axis (vertically), and/or some members of the N resized IP cores by 1% along both the x and y axes (horizontally and vertically). After resizing the N resized IP cores, the macro placer 106 performs macro placements again to place the macros inside the N twice resized IP cores. After performing the macro placements, the verifier 108 performs criteria verification again to check if the macro placements of the N twice resized IP cores satisfy the predetermined standard.

If I of the N twice resized IP cores fail to satisfy the predetermined standard, it implies that the I resized IP cores already have minimal sizes and the I twice resized IP cores are discarded. If J of the N twice resized IP cores satisfy the predetermined standard, it implies that the J twice resized IP cores should be further resized where N=I+J.

By iteratively performing macro placements, criteria verification, and frame resizing, the areas of the T IP cores are reduced to minimal sizes. When the T IP cores cannot be further resized, a floorplanner 112 adjusts a floorplan to optimize positions and frames of the T IP cores on chip top based on a second reinforcement learning model. After the floorplan is adjusted, the macro placer 106 performs macro placements on the T IP cores which were reduced to minimal sizes in the previous iteration.

After recursively resizing the IP cores and adjusting the floorplan, an optimized floorplan is generated when all macro placements of the T IP cores satisfy the predetermined standard and none of the T IP cores can be resized right after the adjustment of floorplan. In this case, an adjusted floorplan is outputted as the final floorplan because the adjusted floorplan is optimized and the areas of the T IP cores cannot be further reduced.

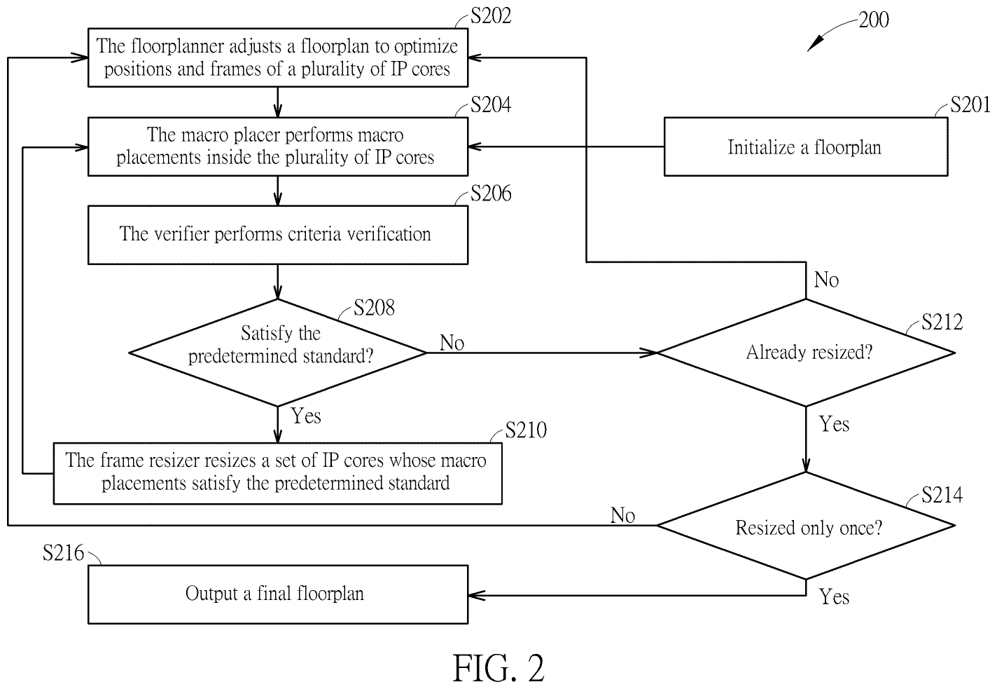

FIG. 2 is a flowchart of a dynamic chip floorplanning method 200 using reinforcement learning according to an embodiment of the present invention. The method 200 includes the following steps:

Step S201: Initialize a floorplan using pre-RTL design and physical design;

Step S202: The floorplanner 112 adjusts a floorplan to optimize positions and frames of a plurality of IP cores;

Step S204: The macro placer 106 performs macro placements inside the plurality of intellectual property (IP) cores;

Step S206: The verifier performs criteria 108 verification;

Step S208: Do the macro placements of the IP cores satisfy the predetermined standard? If so, go to step S210; else, go to step S212;

Step S210: The frame resizer 110 resizes a set of IP cores whose macro placements satisfy the predetermined standard;

Step S212: Are the IP cores already resized? If so, go to step S214; else, go to step S202;

Step S214: Are the IP cores resized only once? If so, go to step S216; else, go to step S202; and

Step S216: Output a final floorplan.

In step S201, an initialized floorplan is generated using pre-RTL design and physical design. Then, go to step S204 for macro placements. In step S204, the macro placements are performed inside the plurality of IP cores based on the first reinforcement learning model by the macro placer 106. After performing the macro placements, the verifier 108 performs criteria verification in step S206. In step S208, the verifier 108 checks if the macro placements of the IP cores satisfy the predetermined standard. If any of the macro placements of the IP cores fails to satisfy the predetermined standard, then step S212 is performed to determine that none of the IP cores has been resized, and step S202 is performed to adjust the floorplan to optimize positions and frames of the plurality of IP cores.

In step S208, if the macro placements of all of the plurality of IP cores satisfy the predetermined standard, the frame resizer 110 resizes the plurality of IP cores in step S210. The frame resizer 110 reduces the areas occupied by some of the plurality of IP cores by 1% along the x-axis (horizontally), some of the plurality of IP cores by 1% along the y-axis (vertically), and/or some of the plurality of IP cores by 1% along both the x and y axes (horizontally and vertically). After resizing the plurality of IP cores, go to step S204 to perform macro placements again and check if the macro placements of the plurality of resized IP cores satisfy the predetermined standard again in step S206.

If some of the plurality of resized IP cores satisfy the predetermined standard, the resized IP cores which satisfy the predetermined standard are outputted to the frame resizer 110 to be further resized in step S210, and remaining resized IP cores which fail to satisfy the predetermined standard are discarded and their corresponding IP cores are regarded as having minimal areas.

In step S208, when no more resized IP core can satisfy the predetermined standard, then go to step S212 to determine that at least some of the plurality of IP cores have been resized. In step S214, since at least some of the plurality of IP cores have been resized at least twice, which is not resized only once, step S202 is performed to have the floorplanner 112 adjust the floorplan to optimize positions and frames of the plurality of IP cores.

In the last iteration, step S202 is performed to adjust the floorplan, the macro placer 106 performs macro placements inside the plurality of IP cores in step S204, the verifier 108 determines that all of macro placements of the plurality of IP cores satisfy the predetermined standard in step S208, the frame resizer 110 resizes the plurality of IP cores in step S210, and the macro placer 106 performs macro placements inside the plurality of resized IP cores in step S204. At this stage, the verifier 108 determines that macro placements of the plurality of resized IP cores all fail to satisfy the predetermined standard in step S208, step S212 determines that the plurality of IP cores are already resized, and step S214 determines that the plurality of IP cores are resized only once, then the adjusted floorplan generated in step S202 would be outputted as the final floorplan in step S216.

In conclusion, the dynamic chip floorplanning method 200, which employs reinforcement learning, significantly reduces human resource expenditure. It autonomously adjusts the floorplan and strategically positions the macros within the IP cores. By iteratively conducting macro placements, criteria verification, frame resizing, and floorplan modifications, the method ensures a compact and efficient layout. These processes are executed automatically, eliminating the need for manual intervention. As a result, the dynamic chip floorplanning method 200 not only enhances power, performance, and area (PPA) metrics but also curtails the reliance on human resources, offering an improvement over traditional techniques.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A dynamic chip floorplanning method, comprising:
a macro placer performing macro placements inside a plurality of intellectual property (IP) cores based on a first reinforcement learning model;
a verifier performing criteria verification to check if the macro placements satisfy a predetermined standard;
a frame resizer resizing a set of IP cores whose macro placements satisfy the predetermined standard, the set of IP cores being a subset of the plurality of IP cores; and
a floorplanner adjusting a floorplan to optimize positions and frames of the plurality of IP cores on chip top based on a second reinforcement learning model when none of the plurality of IP cores is to be further resized.

2. The method of claim 1, wherein the macro placer performing the macro placements inside the plurality of IP cores based on the first reinforcement learning model is the macro placer performing the macro placements inside the plurality of IP cores based on the first reinforcement learning model according to a static random access memory (SRAM) and a netlist.

3. The method of claim 1, wherein the verifier performing criteria verification to check if the macro placements satisfy the predetermined standard is the verifier performing criteria verification to check if global routing congestion, timing, wirelength and hotspot of the macro placements satisfy the predetermined standard.

4. The method of claim 1, wherein the frame resizer resizing the set of IP cores is the frame resizer reducing at least one dimension of a frame of each IP core of the set of IP cores.

5. The method of claim 1, further comprising outputting an adjusted floorplan when the adjusted floorplan is optimized.

6. A dynamic chip floorplanning method, comprising:
a macro placer performing first macro placements inside a plurality of intellectual property (IP) cores based on a first reinforcement learning model;
a verifier performing criteria verification to check if the first macro placements satisfy a predetermined standard; and
a floorplanner adjusting a floorplan to optimize positions and frames of IP cores on chip top based on a second reinforcement learning model if the first macro placements fail to satisfy the predetermined standard.

7. The method of claim 6, wherein the macro placer performing the first macro placements inside the plurality of IP cores based on the first reinforcement learning model is the macro placer performing the first macro placements inside the plurality of IP cores based on the first reinforcement learning model according to a static random access memory (SRAM) and a netlist.

8. The method of claim 6, wherein the verifier performing criteria verification to check if the first macro placements satisfy the predetermined standard is the verifier performing criteria verification to check if global routing congestion, timing, wirelength and hotspot of the first macro placements satisfy the predetermined standard.

9. The method of claim 6, further comprising:
after the floorplanner adjusts the floorplan, the macro placer performing second macro placements inside the plurality of intellectual property (IP) cores based on the first reinforcement learning model;
the verifier performing another criteria verification to check if the second macro placements satisfy the predetermined standard;
a frame resizer resizing a set of IP cores whose second macro placements satisfy the predetermined standard, the set of IP cores being a subset of the plurality of IP cores; and
the floorplanner adjusting the floorplan to optimize the positions and the frames of the plurality of IP cores on chip top based on the second reinforcement learning model when none of the plurality of IP cores is to be further resized.

10. The method of claim 9, wherein the frame resizer resizing the set of IP cores is the frame resizer reducing at least one dimension of a frame of each IP core of the set of IP cores.

11. The method of claim 9, further comprising outputting an adjusted floorplan when the adjusted floorplan is optimized.
